(19) United States
(12) Patent Application Publication
(10) Pub. No.: US 2006/0057543 A1
(43) Pub. Date: Mar. 16, 2006

(54) System for computer assisted driving lessons

(75) Inventor: Arne Roald, Skogveien 5 (NO)

Correspondence Address: VOLPE AND KOENIG, P.C., UNITED PLAZA, SUITE 1600, 30 SOUTH 17TH STREET, PHILADELPHIA, PA, 19103, US

(73) Assignee: Best Practice Deployment AS, Skogveien5 (NO)

(21) Appl. No.: 10/523,537

(22) PCT Filed: Aug. 8, 2003
(86) PCT No.: PCT/NO03/00271

§ 371 Date: Aug. 9, 2005

(30) Foreign Application Priority Data
Aug. 9, 2002 (NO) 20023791

(51) Int. Cl. G09B 9/04

(52) U.S. Cl. 434/62; 434/29

(57) ABSTRACT

A system for computer assisted driving lessons, including a first camera directed forward in the driving direction, a second camera directed at the pupil's eyes as well as recording situations behind the vehicle, a sensor for position data, a processing unit arranged for synchronously storing the signals from the cameras and the sensor. Recordings are made at predefined “difficulty” places along a driving route. The recordings can be displayed later in a “summing up” session with the pupil.

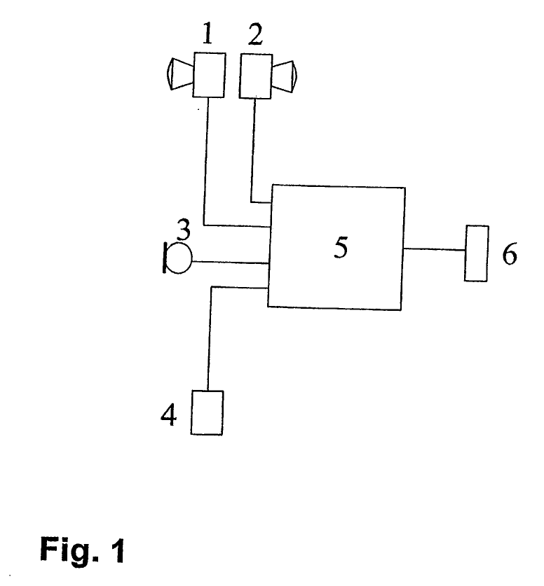

### FIELD OF THE INVENTION

The present invention relates to the field of computer assisted driving lessons for various vehicles such as cars, buses, lorries and motorbikes.

### BACKGROUND

Currently traffic education is a sequential process where the pupils first learn the driving theory through a theory course in classrooms, on the internet or through self studies.

Thereafter the pupil get instructor assisted lessons in practical driving. Mostly, but not always, the instructor will have a plan for the execution of the training process. This in order to ensure the pupil is instructed in managing all major traffic issues: Observe and recognise situations, understand what he/she sees, evaluate alternatives, then act in a correct and safe way.

Situations occurring during the driving lesson are often used for teaching purposes; such as a car entering the main road from a smaller side road, for training of “who has to yield”; the meaning of traffic signs, etc. These unplanned and random situations make any driving lesson a bit unstructured, as an issue belonging at the end the plan may suddenly be taught in the beginning of the plan, just because a situation suited for that training occurred at that time.

This random approach to what issue is being trained, makes the training unstructured and hard to follow for the pupil, resulting in a competence that is often considered low for good and safe driving. A good understanding of current traffic and the ability to “think forward” and anticipate several different outcomes of a given “traffic picture” is sometimes lacking completely.

### SUMMARY

An object of the present invention is to provide a computer assisted driving lessons system that establishes a structure to the training process not found in prior art systems. This ensures that the teaching covers situation by situation as described in the authorities training plan, allowing the teachers' as well as pupils' assessment of whether the goal of that particular part of the training has been achieved.

Another object is to provide a system in which driving lessons become effective and precise relative to the subject taught.

Through said system a strengthening of the current practice is achieved in that the system allows preparation of the training lesson by showing pictures, graphs and drawings of the training route to be used for this particular driving lesson. By repeating the theoretical issues related to a driving lesson before start, recording the driving lesson, electronically marking events and pre-defined “teaching points” of the driving route, summing up and giving precise feedback, giving instruction to additional source of information or homework.

These objects are achieved in a system for computer assisted training lessons, intended for installation in a vehicle used for instructions, which includes an electronic processing unit for display, control, recording and storage of data, a first camera directed forward in the driving direction, a second camera directed at a pupils eyes as well as recording situations behind the vehicle, a microphone, a sensor giving position data, the processing unit being designed for synchronous storage of signals from the cameras, the microphone and the sensor.

The inventive system is used to display picture/video- sequences from a pre-defined or random route as preparation before driving occurs, when driving to register record signals from the same predefined route and after the driving trip display the signals and pictures.

### BRIEF DESCRIPTION OF THE DRAWING

The invention will in the following be described with reference to the enclosed drawing illustrating a schematic view of the inventive system showing the components used.

### DETAILED DESCRIPTION OF THE PREFERRED EMBODIMENTS

The inventive system includes a number of components that are mounted in the vehicle used for training. A camera 1 is recording the “traffic-picture” when driving. This camera 1 being used when driving forward may be switched to a camera looking behind the vehicle when backing the vehicle. An additional camera 2 is directed towards the pupil's eyes for recording of. where his attention is at a given situation. The secondary effect is that the camera 2 will also give an indication of the traffic behind the car, indicating whether there were issues that should have been considered or could have affected the pupil's driving.

The pictures from camera 1 and camera 2 are composed into a “picture in the picture”. Signals and measurements such as turn signals, signals indicating the use of brakes and measurements of speed can be indicated in the picture. The distance to the vehicle in front is another measurement that can be displayed.

A signal processing unit 5 stores the signals and measurements on a suitable storage medium. A microphone 3 is installed inside the vehicle for recording the conversation between pupil and teacher. The signal. from the microphone 3 is also stored in the signal processing unit 5. The processing unit 5 may also be connected to a position sensor 4, as well as means for measuring the distance to a vehicle in front (not shown).

The sensor for position data 4 may be based on several systems. The current preference is to use a Global Positioning System (GPS) receiver. However, the simplest solution is to use the signals from the vehicle's trip meter (odometer). The trip meter is only indicating the distance covered, but this can be enough information if the tour is following a predetermined route.

The signals are recorded in a synchronous mode ensuring that all signals displayed are in “true time” relative to the traffic situation recorded, and are related to the position recorded by the sensor 4. The processing unit 5 is also adapted to replay any part of the recording on a screen 6 mounted inside the vehicle. The recording can also be marked electronically allowing the teacher quickly to step through points of interest in the summing up session. For points manually marked by the teacher 10-15 seconds of recording prior to the marking may be displayed.

As preparation of the driving lesson, the teacher shows a series of pictures, video cuts or sketches of the task to be taught, giving clear instructions of where to focus. This task may be to drive through a predefined route where the training may cover one subject only. Examples on typical subjects may be to understand the meaning of signs, where to yield, etc. The teacher will typically show pictures from this route before the pupil starts driving.

During driving all the described signals are recorded continuously, or just in predefined points. This last option means that the processing unit is adapted to record the signals received in an interval around “critical” positions along the chosen route. When recording continuously random incidents are recorded, making this the preferred way of recording as the random incidents can be relevant for the “summing up” at the end of the driving lesson. A continuous recording will also show the events preceding the incident. This is important to show (later) what should have been observed and reacted on.

In the summing up session at the end of the driving lesson, the teacher display the preferred recording on the screen 6, stepping through each relevant sequence giving reinforcing or corrective feedback as well as indications of how to prepare before next lesson. Instruction to privately assisted volume training may be given. (Private training assistance is not allowed in all countries).

In addition an electronic scorecard of that particular training process will be competed. The scorecard is the quality assurance documentation of the training process. The summing up session, the whole or parts of the recording may be stored with the scorecard for additional documentation.

1. A system for computer assisted driving lessons, for installation in a vehicle used for instructions, comprising an electronic processing unit for display, control, recording and storage of data, a first camera directed forward in a driving direction, a second camera directed at a pupils eyes as well as recording situations behind the vehicle, a microphone, a sensor giving position data, wherein the processing unit is being arranged for synchronous recording and storing signals from the cameras, the microphone and the sensor in pre-defined time intervals at pre-defined positions along a driving route.

2. The system as claimed in claim 1,
in wherein a sensor measuring the distance to any vehicle in front of the vehicle used for instructions, the distance sensor is connected to the processing unit for recording of distances.

3. The system as claimed in claim 1,
wherein the sensor for measuring the position of the vehicle is a trip meter.

4. The system as claimed in claim 1,
wherein the sensor for measuring the position of the vehicle is a Global Positioning System receiver.

5. The system as claimed in claim 1,
wherein the processing unit being is arranged for compressing the recorded signals prior to storage.

6. The system as claimed in claim 1,
wherein the processing unit being is arranged for storing an electronic scorecard, for storing marks given to each pupil for each sequence of the training route.

7. A method for computer assisted driving lessons, comprising displaying picture/video-sequences from pre-defined time intervals in pre-defined positions along a pre-defined route as preparation before driving occurs, when driving to record video signals from the same pre-defined route, and after a driving trip displaying the signals recorded during the trip in said pre-defined time intervals in said pre-defined positions.

8. The method as claimed in claim 7, further comprising manually entering electronic marks at points of particular interest when driving, and after the trip displaying the signals recorded during a pre-defined time interval at said points of particular interest.

9. The method as claimed in claim 7, wherein the signals are registered with a video camera pointing in a driving direction.

10. The method as claimed in claim 9, wherein additional signals are registered with a video camera pointing in a rearward direction, and also recording the eyes of the person driving.

11. The method as claimed in claim 7, wherein the signals are recorded continuously during the trip.

12. The method as claimed in claim 7, wherein the signals are recorded in said pre-defined time intervals at said pre-defined positions, and when an electronic mark has been entered.
